(19) United States
(12) Patent Application Publication
(10) Pub. No.: US 2002/0145266 A1
(43) Pub. Date: Oct. 10, 2002

(54) Two-wheeled or three-wheeled vehicle stand assembly

(76) Inventor: Kevin M. Matthews, Howard City, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/118,284

(22) Filed: Apr. 8, 2002

Related U.S. Application Data
(60) Provisional application No. 60/281,920, filed on Apr. 6, 2001.

(51) Int. Cl. B62H 1/00

(52) U.S. Cl. 280/293

(57) ABSTRACT

A two or three-wheeled vehicle stand includes: a downwardly opening substantially capping member having a substantially C-shaped cross section, a force receiving member engagement area, an upper surface, and an under surface; at least two substantially elongated supports where the elongated supports have a substantially C-shaped cross section and each define an elongated recess and have a capping member engaging end and a tapered anchoring end. The capping member engaging ends of the elongated supports are welded to the under surface of the capping member. The vehicle stand also includes a removable force receiving member engaged with the capping member at the force receiving member engagement area and extending downward from the capping member. The removable force receiving member includes a force receiving surface and a capping member engagable end. A movable force applying mass is slidably engaged with the fixed force receiving member where the force applying mass includes a handle and where the mass applies a downward force to the force receiving surface of the force receiving member when the mass strikes the force receiving surface and thereby applies a force to the elongated supports, and a foot bar engaged with at least one of the elongated supports.

### CROSS-REFERENCE TO RELATED APPLICATION

This application claims priority based on U.S. Provisional Patent Application Serial No. 60/281,920 entitled, “MOUNTING STAND FOR A TWO-WHEEL VEHICLE,” by Kevin M. Matthews, filed Apr. 6, 2001, the disclosure of which is hereby incorporated by reference in its entirety.

### BACKGROUND OF THE INVENTION

Motorcycles, bicycles, generally, and other two-wheeled or three-wheeled vehicles have become tremendously popular in recent years as people search for new avenues for entertainment and fitness. As the designs of these vehicles have evolved, they increasingly are designed without a vehicle kickstand or other device for keeping the vehicle in an upright position and off the ground or other surface. Oftentimes, even if a vehicle kickstand is present on the vehicle, the kickstand does not get used. Currently, when a child or adult ceases to use a mountain bike, bicycle, tricycle, BMX-type bike or other two or three-wheeled manual or motor driven vehicles, which may or may not have a self contained vehicle stand, he or she will occasionally place or throw (more often children) these expensive vehicles onto the ground or other hard surface. In the worst case, this potentially damages the vehicle and, at the very least, creates a cluttered yard or other area. Accordingly, there is a significant need for a heavy duty, inexpensive easy to assemble parking module/vehicle stand assembly that can be easily transported from one location to another and inserted into the ground or into an above-ground base to provide an established location for an individual to park his or her two or three-wheeled vehicle for storage. When this is done, the vehicle does not contact the ground in a damaging manner. Moreover, an established location for storing the vehicle promotes storage in the assembly by all individuals, especially, children thereby preventing damage to the vehicle.

### SUMMARY OF THE INVENTION

The present invention improves upon the earlier two-wheeled and three-wheeled vehicle stands by providing a two or three-wheeled vehicle stand assembly having a capping member; at least two downwardly extending elongated supports, which define at least one vehicle receiving area and engage the capping member; a force receiving member engaged with and extending downward from the capping member where the force receiving member includes a capping member engagement portion and a force receiving portion, which includes a force receiving surface, and a movable force applying member engaged with the force receiving member wherein the movable force applying member applies a downward force to the force receiving surface and also to the downwardly extending supports and the assembly as a whole.

In yet another embodiment of the present invention, a two or three-wheeled vehicle stand assembly includes: a capping member; at least two downwardly extending elongated supports engaged with the capping member each having a capping member engaging end and a tapered anchoring end and where at least one of the downwardly extending elongated supports further includes an aperture; and at least one foot bar engaged with at least one of the downwardly extending elongated supports by utilizing the aperture.

In still another embodiment of the present invention, a two or three-wheeled vehicle stand includes: a downwardly opening substantially capping member having a substantially C-shaped cross section, a force receiving member engagement area, an upper surface, and an under surface; at least two substantially elongated supports where the elongated supports have a substantially C-shaped cross section and each define an elongated recess and have a capping member engaging end and a tapered anchoring end. The capping member engaging ends of the elongated supports are welded to the under surface of the capping member. The vehicle stand also includes a removable force receiving member engaged with the capping member at the force receiving member engagement area and extending downward from the capping member. The removable force receiving member includes a force receiving surface and a capping member engagable end. A movable force applying mass is slidably engaged with the fixed force receiving member where the force applying mass includes a handle and where the mass applies a downward force to the force receiving surface of the force receiving member when the mass strikes the force receiving surface and thereby applies a force to the elongated supports, and a foot bar engaged with at least one of the elongated supports.

In yet another embodiment of the present invention, a two or three-wheeled vehicle stand assembly includes: a capping member having a substantially C-shaped cross-section; at least two supports releasably engaged with the capping member where at least one of the elongated supports has an aperture; at least one foot bar engaged with at least one of the elongated supports using the aperture; and an above-ground support device having two substantially M-shaped side sections each including: two outwardly projecting foot portions, two preferably curved peak portions having a foot portion side, and a preferably curved valley portion; an elongated support receiving recess engaged to each side section for receiving the elongated supports; and at least two elongated connecting members interconnecting the substantially M-shaped side sections.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of one embodiment of the present invention showing a force applying member removably engaged to the capping member using a nut;

FIG. 2 is a perspective view of another embodiment of the present invention;

FIG. 3 is a perspective view of another embodiment of the present invention showing tubular or solid cylindrical elongated supports;

FIG. 4 is a perspective view of yet another embodiment of the present invention;

FIG. 5 is a perspective view of yet another embodiment of the present invention where the vehicle stand assembly includes a surface engaging base unit;

FIG. 6 is a perspective view of yet another embodiment of the present invention;

FIG. 7 is a perspective view of another embodiment of the present invention having substantially U-shaped dividers;

FIG. 8 is a perspective view of yet another embodiment of the present invention having substantially U-shaped dividers;

FIG. 9 is a perspective view of another embodiment of the present invention showing the elongated supports having reinforcing ribs;

FIG. 10 is a perspective view of another embodiment of the present invention where the vehicle stand assembly includes a surface engaging base unit;

FIG. 11 is a cross-sectional view along line XI-XI of FIG. 9 showing strengthening ribs on the under surface of the capping member and a threaded recess for receiving the removable force applying member on the under surface of the capping member;

FIG. 12 is a plan view of the surface engaging base unit shown in FIG. 10;

FIG. 12A is a plan view of another embodiment of the surface engaging base unit;

FIG. 12B is a perspective view of another embodiment of the present invention where the vehicle stand assembly includes an alternative surface engaging base unit;

FIG. 13 is an enlarged partially exploded view showing two possible removable engagement means for attaching the removable force receiving member to the capping member (nut or cotter pin);

FIG. 14 is a cross-sectional view along line XIV-XIV of FIG. 3 showing insertion of the force applying assembly inserted through a slot in the bridging member and rotated;

FIG. 15A is an enlarged view of the under surface of the capping member showing an alternative embodiment of the bridging member(s), metal (steel) rods; and

FIG. 15B is an enlarged view of the under surface of the capping member showing an alternate embodiment of the bridging members, two metal (steel) plates.

### DETAILED DESCRIPTION OF THE PREFERRED EMBODIMENT(S)

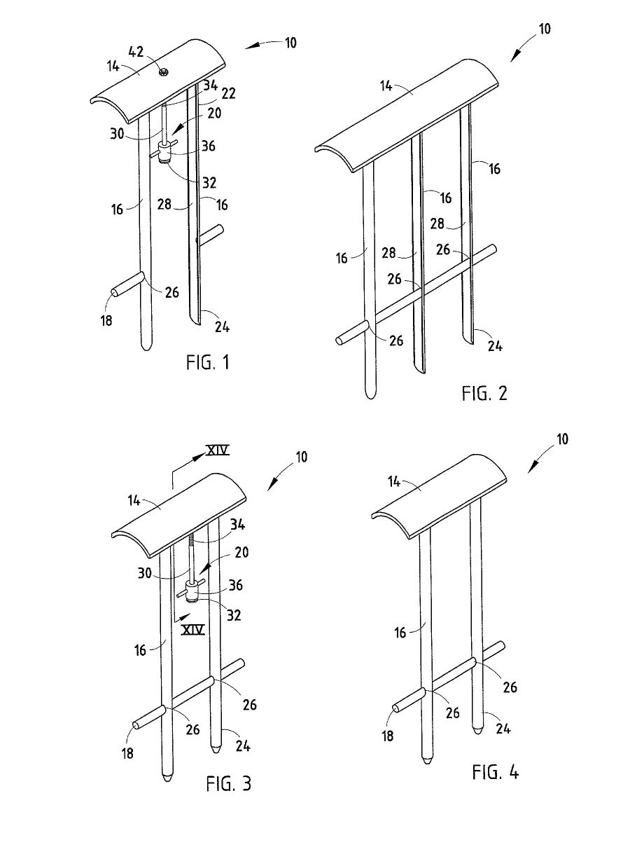

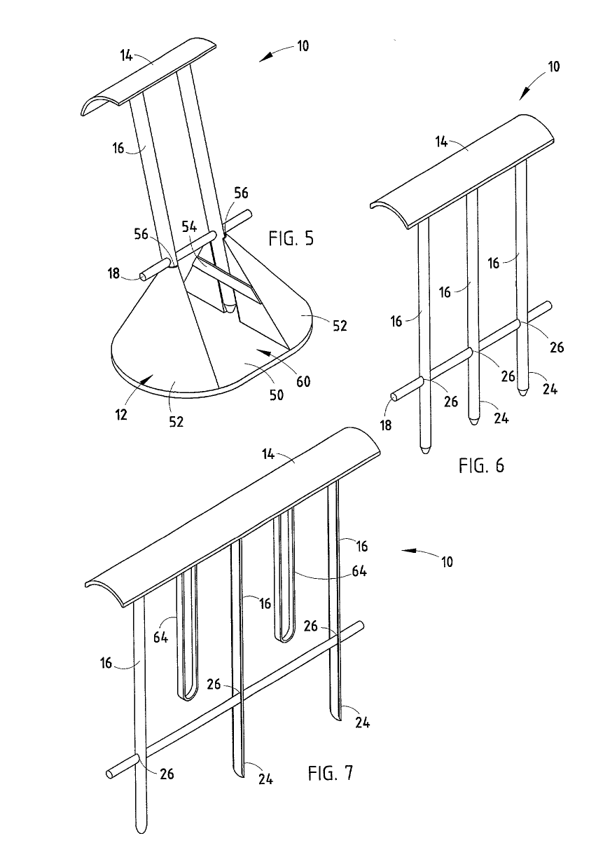

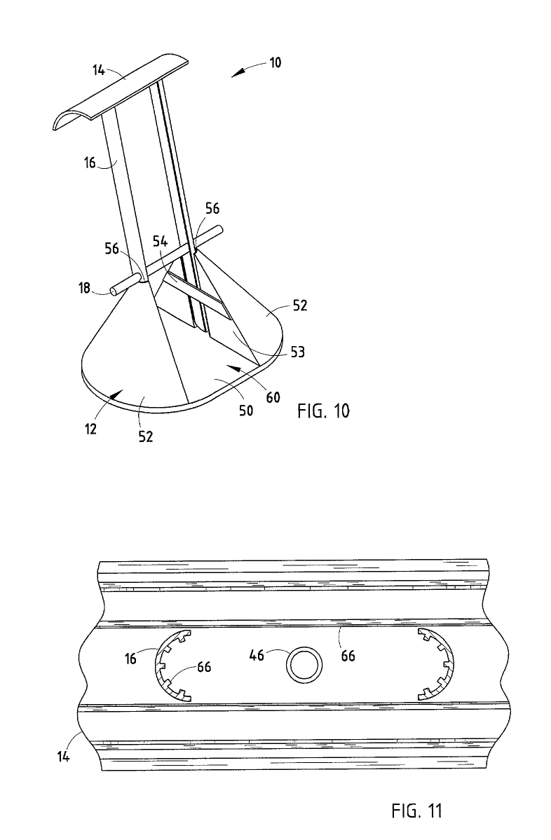

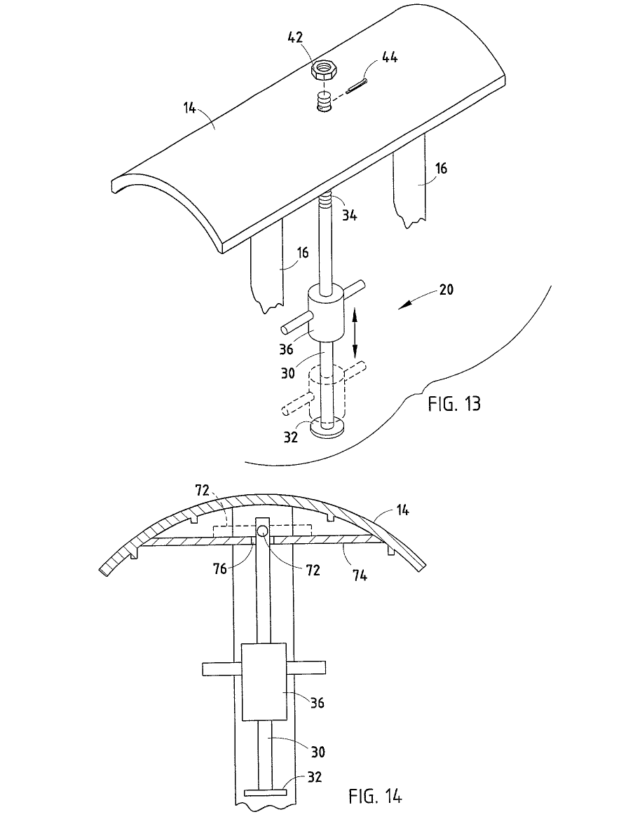

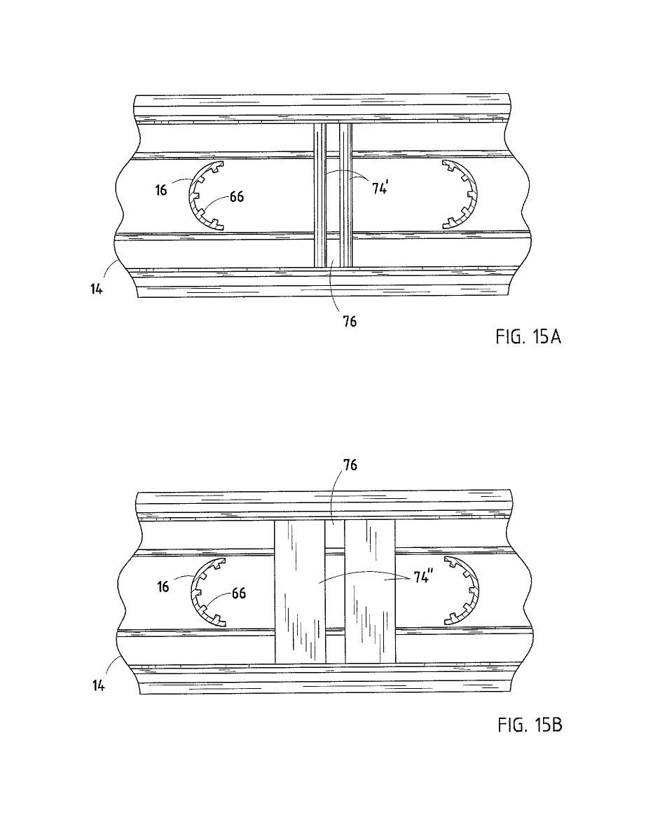

FIGS. 1-10 show various embodiments of the present invention, a two-wheeled or three-wheeled vehicle stand assembly with or without the above-ground support device/base 12. The vehicle stand assembly 10 generally comprises a capping member 14, at least two elongated, downwardly extending support members 16, and at least one foot bar 18. The vehicle stand assembly 10 also may optionally and advantageously further employ at least one removable force applying assembly 20 (see FIG. 13), which applies a hammer-like force to drive the elongated, downwardly extending supports 16 into the ground. Additionally, for above-ground use, the vehicle stand assembly 10 may be used in conjunction with the above-ground support device/base 12 (see FIGS. 5 and 10). The above-ground support device is used whenever the assembly may not readily be inserted into the ground or other surface. The above-ground support device may also be used when one does not want to damage a manicured lawn by inserting the assembly into the ground. Because the base allows the vehicle stand to be used on concrete or asphalt, the vehicle stand assembly 10 may be used in a garage or on a driveway. Moreover, the entire design of the present invention may be specially manufactured to accommodate any size or style of vehicle because of, for example, a bikes distinct tire, wheel, or frame design. The entire design of the present invention may also be specially manufactured to accommodate multiple bikes or other vehicles and may be offered as a kit and easily assembled by the end user.

The capping member 14 preferably has a substantially C-shaped cross section such that the shallow concave surface is directed downward. Also, the capping member preferably has at least one capping member bridging member 74, a plate or plates 74″ or steel rod 74′, that bridges the concave under surface of the capping member. When a bridging member is used, it establishes an alternate, substantially flat, under surface for the capping member. This concave/curved design provides added strength, especially when a bridging member is used, and also provides protection from the environment because rain and other precipitation more easily flows off of the surface of the capping member. While the capping member 14 is preferably substantially C-shaped, the capping member 14 may be flat, substantially V-shaped, or another suitable design. The capping member 14 may also contain any number of strengthening ribs along the length or width of its surface, preferably its under surface, to provide added durability. The capping member may be of any suitable length or width, but is preferably about four inches to about six inches wide, preferably four inches wide, before the metal capping member is bent. The bent capping member will be about 3½ inches to about five inches wide. The length will largely depend on the number of elongated, downwardly extending supports utilized.

The elongated, downwardly extending support members 16 include a capping member engaging end 22 and a ground/surface engaging end 24, which is preferably tapered to allow for easier insertion of the vehicle stand assembly 10 into the ground. The capping member engaging end 22 of the elongated, downwardly extending support members 16 may be engaged to the capping member by any suitable arrangement. The elongated, downwardly extending support members 16 may be engaged using a nut and bolt type arrangement, but may also be welded to the capping member. Additionally, when a capping member bridging member 74 is welded or otherwise engaged to the under surface of the capping member, a groove similar to the groove 76 shown in FIG. 14, 15, and 15A for engaging the force applying assembly, in or defined by the bridging member may receive the support member 16 such that the support member is engaged to the capping member by inserting the capping member engaging end of the support member, which has been adapted to be inserted into the groove, and twisting the support member. Typically, the capping member engagement ends of the support member are substantially T-shaped when using this type of engagement.

The capping member may comprise a “female-type” engagement area on the under surface, which matingly receives the capping member engaging end of the elongated, downwardly extending support members 16 such that when the capping member and the elongated, downwardly extending support members 16 are welded together, added support and strength are provided. The female-type engagement area on the under surface of the capping member preferably is defined by a wall of metal, plastic, wood, or other material shaped to matingly fit the capping member engagement end of the elongated, downwardly extending support members 16. The mating engagement and weld connection provides a heavy-duty construction, which is desired by consumers. Of course, as will be discussed further below, since the vehicle stand may be manufactured of a material other than a weldable material, a weld is sometimes not possible. Nevertheless, the mating arrangement still provides some additional support.

The elongated, downwardly extending support members 16, like the capping member, preferably have a substantially C-shaped cross section, but may be hallow or solid tubular structures, flat, or have a substantially V-shaped cross section as well. The elongated, downwardly extending support members 16 may be of any suitable length or width, but, when made of metal, are preferably about one inch to about three inches wide before the metal is bent. The bent elongated, downwardly extending support members 16 will be about one inch to about three inches wide. The length will depend on the type of vehicle.

The ground/surface engaging end 24 of the elongated, downwardly extending support members 16 is preferably designed for easy insertion into the ground. The ground-breaking tip of the ground/surface engaging end is preferably tapered to provide a blade-like surface to facilitate insertion of the assembly into the ground. Obviously, the tapered, ground-breaking tip on the end of the ground/surface engaging end 24 is not absolutely required, but is certainly advantageous for inserting the vehicle stand assembly 10 into hard earth, clay, sand, or other hard or dense material into which the assembly may be driven. Additionally, a separate tip attachment that is of thinner material may be removably or permanently attached to the ground/surface engaging end 24 to further facilitate insertion of the ground/surface engaging end 24 into harder earthen materials. The tip attachments are preferably about two inches to six inches long and have about the same width as the elongated, downwardly extending supports, but also are preferably tapered.

To further facilitate insertion of the assembly 10 into the earth, the assembly 10 preferably further includes at least one foot bar 18, which is preferably a cylindrical rod. A single foot bar 18 or multiple foot bars 18 may be attached to any number of the elongated, downwardly extending support members 16. The foot bar may be attached to the elongated, downwardly extending support members 16 by a nut and bolt-type arrangement or by a weld. When this is done in the preferred embodiment, the substantially C-shaped elongated, downwardly extending support members 16 define an elongated recess 28, which contains the nut and prevents the exposed nut on the inside surface of the elongated, downwardly extending support members 16 from contacting and damaging the vehicle when the vehicle is inserted into the vehicle stand assembly 10.

In another embodiment, a foot bar 18 is spaced within or through aligned apertures 26 in the elongated, downwardly extending support members 16, such that the foot bar 18 extends between at least two elongated, downwardly extending support members 16, but may extend beyond the elongated, downwardly extending support members 16 on either side or both sides. The apertures 26 of the elongated, downwardly extending support members 16 are preferably from about four to about ten inches from the tapered ground/surface engaging end 24. Greater length from the ground/surface engaging end is required for heavier vehicles as more of the support needs to be inserted into the ground for stability. The elongated, downwardly extending support members 16 are preferably driven down until the foot bar contacts the ground or other surface.

The removable force applying assembly 20 (see FIG. 13) includes a force receiving member 30, which is preferably a threaded steel rod or bolt having a welded or integrated force receiving surface 32 (usually a hard, circular disc welded to the head of a bolt) and a capping member engaging end 34, which is preferably the threaded end of the steel rod or bolt. The force applying assembly 20 further includes a mass 36, which is preferably a steel cylinder, positioned in slidable engagement with the force receiving member 30. The mass 36 may further include “T-handle” 38 or other suitable handle, which allows a user to more easily grip the mass 36 and slidably move mass 36 up and down to apply force to force receiving surface 32 of force receiving member 30. While the force applying assembly is preferably removable, it may be permanently engaged if so desired.

In use, the removable force applying assembly may be attached to the capping member by inserting the capping member engaging end 34 through an optional aperture 40 in the capping member 14 and engaging a nut 42 with the threads of the capping member engaging end 34. There may be any number of apertures at spaced apart intervals in the capping member to provide various locations for applying force to the assembly. This is especially desirable when there are multiple elongated, downwardly extending supports. Preferably, the force applying assembly may be removably attached to the capping member at a substantially central location between each pair of the elongated, downwardly extending supports.

In another embodiment, the capping member engaging end is adapted to engage a cotter pin 44 or other quick-release clamping device such that when the capping member engaging end is inserted through any one of the optional capping member aperture(s), the cotter pin 44 or other quick-release clamp readily engages the capping member engaging end of the force applying assembly.

In another embodiment, the under surface of the capping member is either formed having at least one threaded recess to receive a threaded capping member engaging end or at least one separate mounting plate having at least one threaded recess may be engaged, preferably by a weld, to the bottom of the capping member. Also, a nut may be attached by a weld to the under surface of the capping member. The integrated threaded recess(es) and the threaded recess(es) of the mounting plate(s) are adapted to receive the threaded capping member engaging end of the removable force applying assembly. This design provides a cleaner look since a visible aperture in the capping member is not required. As with the aperture(s), there may be any number of spaced apart threaded recess(es) to provide various locations for applying force to the assembly. Additionally, any combination of the above embodiments may also be employed.

As will be apparent to one of ordinary skill, and as discussed briefly above, the removable force applying assembly and the capping member may be configured to utilize multiple force applying assemblies at a given time at various locations along the capping member or a single force applying assembly at any of multiple optional locations on the capping member.

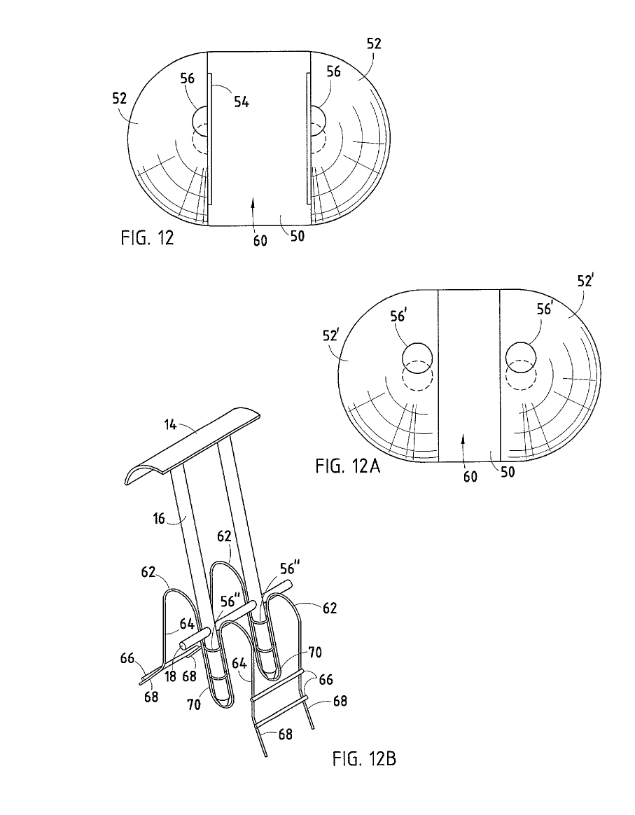

The vehicle stand assembly 10 is designed to engage an above-ground support device/base 12 (FIGS. 12, 12A, 12B). The above-ground support device/base 12 (FIGS. 12, 12A) includes a surface engaging base 50, and side sections 52 defining a vehicle wheel receiving channel 60. The vehicle wheel receiving channel 60 may be of any width suitable to receive the vehicle wheel, but is preferably about 1¾ inch to about three inches wide. Each side section 52 may be any suitable shape, but each side section also defines at least one elongated, downwardly extending support member engaging recess 56. When the foot bar 18 is spaced between the elongated, downwardly extending supports, the support member engaging recesses are preferably at an angle from about twenty degrees to about forty-five degrees, most preferably, about thirty degrees to about thirty-five degrees, from a line perpendicular with the base. This configuration allows for enough clearance for the vehicle wheel to avoid contacting the foot bar. When only side foot bars are used, the support member engaging recesses do not have to be at any particular angle; however, they are usually either at an angle as above or perpendicular to the base. Applicant has found that when metal, preferably steel, aluminum, or sheet metal, is used to form the side sections 52, a conical shape is most preferred and may be manufactured by metal stamping or bending processes. When the recess 56 is partially opened on one side, as shown if FIGS. 5 and 10, an optional retention plate 54 may be engaged, preferably by a weld, to the inner surface 53 of the side sections to further facilitate retention of the elongated, downwardly extending support members 16 within the support member engaging recesses 56. The optional retention plate preferably spans the open support member engaging recess 56 and is preferably about six inches long.

As can be seen in FIG. 12A, the support member engaging recesses 56′ may be recesses within the side sections 52′, which are not partially open, but instead substantially supported by the material of the side sections, which provide added support, but applicant believes it would be difficult to manufacture from metal, but may easily be made from plastic by injection molding or other similar processes.

Additionally, in either of the above embodiments, side sections 52 may further include a mass or weight such as sand, gravel, or other material to provide added stability to the above-ground support device/base 12 when the vehicle stand assembly 10 is engaged with it.

As seen in FIG. 12B, the above-ground support device/base 12 may be constructed having substantially M-shaped side sections, which are preferably made of bent metal rod, but could also be made of plastic. Each side section preferably contains foot portions 68, two preferably curved peak portions 62 having a foot portion side, and a valley portion 70. The support receiving recesses 56″ are attached (welded) to the side sections, preferably at the shallow valley portion 70 of the side sections. The recesses may be metal or plastic cups or just bent metal rods or any other suitable design for receiving the elongated supports. The recesses, as discussed above, receive the elongated, downwardly extending support members 16 at an angle when the foot bar 18 is spaced between the elongated supports, but may be configured to receive the elongated supports perpendicularly when the foot bar 18 is at the side of the elongated supports. The side sections are connected to one another with at least two, but preferably three or more elongated connecting members 66, which are typically metal rods, but could be plastic rods as well. In the preferred case, one connecting member is connected to each side section where the foot portion meets the foot portion side of the peak portions on the vehicle entrance end and two or more connecting members connect the opposite sides of the side sections as seen in FIG. 12B. When a metal structure is used, the components are usually spot welded together. When metal rods are used, they are preferably about ¼ inch to about ½ inch in diameter.

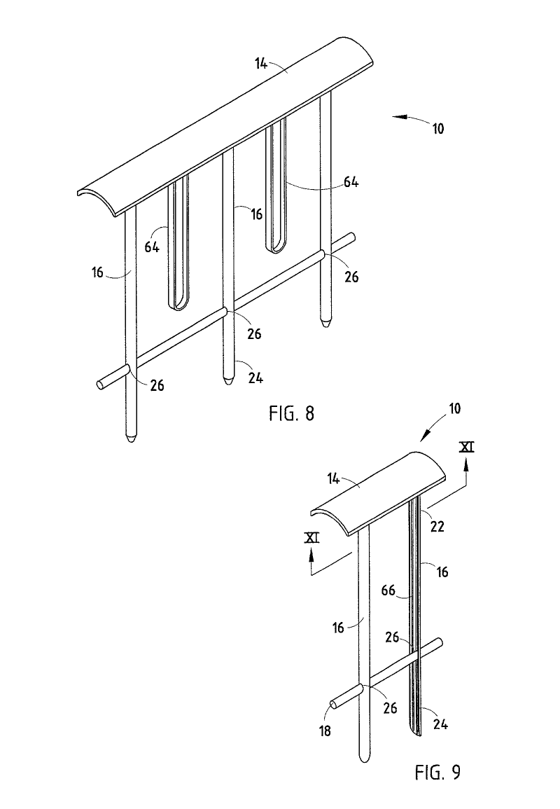

Another feature of the present invention is an optional downwardly extending divider 64, which may be engaged to the capping member by any of the means discussed above by which the removable force applying assembly and the elongated supports 16 are removably attached to the capping member. The divider may be a cylindrical rod, or as shown in FIGS. 7 and 8, may be a U-shaped divider. The dividers may also be attached to the under surface of the capping member when a bridging member(s) is used. When a bridging member is used, the dividers may have a capping member engagement end that is slotted. The slotted end or, when the divider is U-shaped, ends may be inserted into T-shaped grooves in the bridging member. When this attachment method is used, U-shaped dividers are preferably used and the two slotted ends pressed together when inserted into two T-shaped grooves such that when the slotted ends are released, they spring back to their natural position and are better retained in the T-shaped grooves. The optional dividers 64 may be positioned at any suitable location between the elongated, downwardly extending support members 16 to define additional vehicle retention areas. The dividers are especially useful when there is a larger space between two downwardly extending support members 16.

The above description is considered that of the preferred embodiment only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A two or three-wheeled vehicle stand assembly comprising:
a capping member;
at least two downwardly extending elongated supports defining at least one vehicle receiving area and engaged to the capping member;
a force receiving member engaged with and extending downward from the capping member wherein the force receiving member comprises a capping member engagement portion and a force receiving portion where the force receiving portion comprises a force receiving surface; and
a movable force applying member engaged with the force receiving member wherein the movable force applying member applies a downward force to the force receiving surface and thereby to the downwardly extending supports.

2. The two or three-wheeled vehicle stand assembly of claim 1, wherein the downwardly extending elongated supports comprise a cross section wherein the cross section comprises a cross section chosen from a substantially C-shaped or substantially V-shaped cross section.

3. The two or three-wheeled vehicle stand assembly of claim 2, wherein the cross section of the downwardly extending elongated supports define an elongated recess and further comprises a first foot bar engaged to at least one of the downwardly extending elongated supports.

4. The two or three-wheeled vehicle stand assembly of claim 3 further comprising a second foot bar engaged to at least one downwardly extending elongated support.

5. The two or three-wheeled vehicle stand assembly of claim 2, wherein the capping member comprises an upper surface, an under surface, and a substantially C-shaped or substantially V-shaped cross section.

6. The two or three-wheeled vehicle stand assembly of claim 2, wherein the at least two downwardly extending elongated supports further comprise at least one aperture.

7. The two or three-wheeled vehicle stand assembly of claim 6 further comprising a foot bar extending through the aperture of at least one of the downwardly extending elongated supports.

8. The two or three-wheeled vehicle stand assembly of claim 7, wherein the foot bar is spaced within the apertures of at least two downwardly extending elongated supports.

9. The two or three-wheeled vehicle stand assembly of claim 1 further comprising a vehicle stand receiving device comprising a base, at least two downwardly extending elongated support retention apertures at an angle of from about twenty degrees to about forty-five degrees from perpendicular to the base for receiving and removably engaging the at least two downwardly extending elongated supports, and a vehicle receiving channel spaced between two of the downwardly extending elongated support retention apertures.

10. The two or three-wheeled vehicle stand assembly of claim 1, wherein the capping member and the at least two downwardly extending elongated supports comprise at least one material chosen from the group comprising aluminum, steel, plastic, and wood.

11. The two or three-wheeled vehicle stand assembly of claim 1, wherein the at least two downwardly extending supports each comprise a capping member engaging end and a anchoring end wherein the anchoring end is substantially tapered.

12. The two or three-wheeled vehicle stand assembly of claim 1 further comprising a nut and wherein the capping member engagement portion of the force receiving member is at least partially threaded and is removably engaged to the capping member by engaging the threads of the capping members engagement portion with the nut.

13. The two or three-wheeled vehicle stand assembly of claim 1 further comprising a cotter pin and wherein the capping member further comprises an aperture and the capping member engagement portion of the force receiving member is adapted to receive the cotter pin and engage the force receiving member with the capping member when the force receiving member is inserted into the aperture of the capping member.

14. The two or three-wheeled vehicle stand assembly of claim 12, wherein the downwardly extending elongated supports are welded to the capping member.

15. The two or three-wheeled vehicle stand assembly of claim 13, wherein the downwardly extending elongated supports are welded to the capping member.

16. The two or three-wheeled vehicle stand assembly of claim 5, wherein the downwardly extending elongated supports are welded to the capping member.

17. The two or three-wheeled vehicle stand assembly of claim 1, wherein the downwardly extending elongated supports are welded to the capping member.

18. The two or three-wheeled vehicle stand assembly of claim 1 further comprising at least one downwardly extending dividing member engaged with the capping member and spaced between two of the downwardly extending elongated supports.

19. The two or three-wheeled vehicle stand assembly of claim 18, wherein the dividing member is substantially U-shaped.

20. The two or three-wheeled vehicle of claim 1, wherein the capping member further comprises at least one strengthening rib.

21. The two or three-wheeled vehicle stand assembly of claim 15, wherein the capping member further comprises at least two reinforcing wall assemblies defining elongated support receiving areas for matingly receiving the capping member engaging ends of the at least two downwardly extending supports.

22. The two or three-wheeled vehicle stand assembly of claim 1, wherein the force receiving member is releasably engaged to the capping member.

23. A two or three-wheeled vehicle stand assembly comprising:
a capping member;
at least two downwardly extending elongated supports engaged with the capping member and each comprising a capping member engaging end and a tapered anchoring end wherein at least one of the downwardly extending elongated supports further comprises an aperture; and
at least one foot bar engaged with at least one of the downwardly extending elongated supports by utilizing the aperture.

24. The two or three-wheeled vehicle stand assembly of claim 23 further comprising a force receiving member engaged with and extending downward from the capping member wherein the force receiving member comprises a force receiving surface; and
a movable force applying mass engaged with the fixed force receiving member wherein the force applying member applies a downward force to the force receiving surface of the force receiving member and thereby to the downwardly extending elongated supports into a surface.

25. The two or three-wheeled vehicle stand assembly of claim 24, wherein the at least two downwardly extending elongated supports comprise a substantially C-shaped cross section.

26. The two or three-wheeled vehicle stand assembly of claim 25, wherein the C-shaped cross section of the downwardly extending elongated supports define an elongated recess.

27. The two or three-wheeled vehicle stand assembly of claim 26, wherein the capping member comprises a substantially C-shaped cross section.

28. The two or three-wheeled vehicle stand assembly of claim 24, wherein the foot bar extends through the apertures of the downwardly extending elongated support.

29. The two or three-wheeled vehicle stand assembly of claim 28, wherein the foot bar extends beyond and outside of at least one of the downwardly extending elongated supports.

30. The two or three-wheeled vehicle stand assembly of claim 24 further comprising a vehicle stand assembly base comprising at least two downwardly extending support retention apertures for receiving and removably engaging at least two downwardly extending elongated supports and a vehicle receiving channel between the support retention aperture of the vehicle stand assembly base.

31. The two or three-wheeled vehicle stand assembly of claim 30 further comprising at least one retention member and wherein the downwardly extending elongated supports are further retained within the support retention apertures by a retention member engaged across the width of at least one of the retention apertures.

32. The two or three-wheeled vehicle stand assembly of claim 24, wherein the capping member and the downwardly extending elongated supports comprise at least one material chosen from the group comprising aluminum, steel, plastic, and wood.

33. The two or three-wheeled vehicle stand assembly of claim 24 further comprising a nut and wherein the capping member engagement portion of the force receiving member is at least partially threaded and is removably engaged to the capping member by engaging the threads of the capping member engagement portion with the nut.

34. The two or three-wheeled vehicle stand assembly of claim 24 further comprising a cotter pin and wherein the capping member further comprises an aperture and the capping member engagement portion of the force receiving member is adapted to receive the cotter pin and engage the force receiving member with the capping member when the force receiving member is inserted into the aperture of the capping member.

35. The two or three-wheeled vehicle stand assembly of claim 33, wherein the downwardly extending elongated supports are welded to the capping member.

36. The two or three-wheeled vehicle stand assembly of claim 25, wherein the downwardly extending elongated supports are welded to the capping member.

37. The two or three-wheeled vehicle stand assembly of claim 34, wherein the downwardly extending elongated supports are welded to the capping member.

38. The two or three-wheeled vehicle stand assembly of claim 24, wherein the downwardly extending supports are welded to the capping member.

39. The two or three-wheeled vehicle stand assembly of claim 24 further comprising at least one downwardly extending dividing member engaged with the capping member and spaced between two of the downwardly extending elongated supports.

40. The two or three-wheeled vehicle stand assembly of claim 39, wherein the dividing member is substantially U-shaped.

41. The two or three-wheeled vehicle stand assembly of claim 24, wherein the capping member further comprises at least one strengthening rib.

42. A two or three-wheeled vehicle stand comprising:
a downwardly opening capping member comprising a substantially C-shaped cross section, a force receiving member engagement area, an upper surface, and an under surface;
at least two substantially elongated supports comprising a substantially C-shaped cross section and wherein the elongated supports each define an elongated recess and comprise a capping member engaging end and a tapered anchoring end,
wherein the capping member engaging ends of the elongated supports are welded to the under surface of the capping member;
a removable force receiving member engaged with the capping member at the force receiving member engagement area and extending downward from the capping member wherein the removable force receiving member comprises a force receiving surface and a capping member engagable end;
a movable force applying mass slidably engaged with the fixed force receiving member wherein the force applying mass comprises a handle and wherein the mass applies a downward force to the force receiving surface of the force receiving member when the mass strikes the force receiving surface and thereby applies a force to the elongated supports; and
a foot bar engaged with at least one of the elongated supports.

43. The two or three-wheeled vehicle stand assembly of claim 42 further comprising an above-ground support device comprising a base, at least two support retention areas for receiving at least two elongated supports, and a vehicle wheel receiving channel spaced between two of the support retention areas wherein the support retention apertures are at an angle of from about twenty degrees to about forty-five degrees from perpendicular to base.

44. The two or three-wheeled vehicle stand assembly of claim 43, wherein the above-ground support device further comprises a above-ground support device stabilizing mass engaged with the base to provide added stability to the above-ground support device.

45. The two or three-wheeled vehicle stand assembly of claim 44, wherein at least one of the elongated supports further comprise at least one aperture and wherein the foot bar engages elongated supports utilizing the apertures.

46. The two or three-wheeled vehicle stand assembly of claim 45, wherein at least two of the elongated supports further comprise substantially aligned apertures and wherein the foot bar is spaced within the apertures of at least two of the elongated supports.

47. The two or three-wheeled vehicle stand assembly of claim 46, wherein the foot bar extends through the apertures of at least two of the elongated supports.

48. The two or three-wheeled vehicle stand assembly of claim 42, wherein the capping member and at least two of the elongated supports comprise at least one material chosen from the group comprising aluminum, steel, plastic, and wood.

49. The two or three-wheeled vehicle stand assembly of claim 42 further comprising a nut and wherein the capping member engagable end of the removable force receiving member is at least partially threaded and is removably engaged to the capping member by engaging the threads of the capping member engagable end with the nut when the removable force receiving member is spaced within the force receiving member engagement area.

50. The two or three-wheeled vehicle of claim 42 further comprising a cotter pin engaging the removable force receiving member wherein the removable force receiving member is adapted to receive the cotter pin and engage the removable force receiving member with the capping member when the removable force receiving member is spaced within the force receiving member engagement area.

51. The two or three-wheeled vehicle stand assembly of claim 42, wherein the capping member engagable end of the force receiving member comprises threads and the force receiving member engagement area of the capping member comprises a threaded recess on the under surface of the capping member adapted to engage the threads of capping member engagable end of the force receiving member.

52. The two or three-wheeled vehicle stand assembly of claim 42, wherein the at least two elongated supports are welded to the capping member.

53. The two or three-wheeled vehicle stand assembly of claim 42, wherein the elongated supports and the capping member further comprise at least one strengthening rib.

54. A two or three-wheeled vehicle stand assembly comprising:
a capping member comprising a substantially C-shaped cross-section;
at least two supports releasably engaged with the capping member and wherein at least one of the elongated supports further comprises an aperture;
at least one foot bar engaged with at least one of the elongated supports by utilizing the aperture; and
an above-ground support device comprising: two substantially M-shaped side sections each comprising two outwardly projecting foot portions, two curved peak portions having a foot portion side, and a valley portion; an elongated support receiving recess engaged to each side section for receiving the elongated supports; and at least two elongated connecting members interconnecting the substantially M-shaped side sections.
